(19) United States
(12) Patent Application Publication
(10) Pub. No.: US 2008/0054498 A1
(43) Pub. Date: Mar. 6, 2008

(54) ACCELERATOR PUMP COVERS AND SYSTEMS AND METHODS RELATING THERETO

(75) Inventor: Simon James Lewis, Frisco, TX (US)

Correspondence Address: GREENBERG TRAURIG, LLP, 1200 SEVENTEENTH STREET, SUITE 2400, DENVER, CO, 80202, US

(73) Assignee: Merge Racing Technologies, Dallas, TX (US)

(21) Appl. No.: 11/870,863

(22) Filed: Oct. 11, 2007

Related U.S. Application Data
(60) Provisional application No. 60/915,602, filed on May 2, 2007.

(51) Int. Cl. F02M 11/00

(52) U.S. Cl. 261/41.1

(57) ABSTRACT

An accelerator pump cover is provided. The accelerator pump cover includes a body having a cavity for receiving fuel, a first passageway for allowing passage of fuel into the cavity, a second passageway for allowing passage of fuel out of the cavity, and an adjustable member at least partially disposed within a portion of at least one of the first passageway and the second passageway.

### CROSS-REFERENCE TO RELATED APPLICATION

This patent application claims priority under 35 U.S.C. §119(e) to U.S. Provisional Patent Application No. 60/915,602, entitled “CARBURETOR DIAPHRAGM COVER AND SYSTEMS AND METHODS RELATING THERETO”, filed May 2, 2007, and which is incorporated herein by reference.

### BACKGROUND

A modern single-cylinder engine (e.g., a four stroke engine of an off-road motorcycle) is designed to generally run on a mixture of fuel and air. For a four stroke motorcycle, the engine generally performs best at an air-to-fuel ratio of from about 12:1 to 14:1, depending upon a few variable factors, such as the type of fuel and atmospheric conditions. When the air-to-fuel ratio deviates from this range, various detrimental effects may occur, such as loss of power, poor starting and/or damage to internal components, such as the inlet and exhaust valves. In some circumstances, non-optimal air to fuel ratios may cause the engine to overheat.

When the throttle of an internal combustion engine is opened rapidly, the engine can quickly suck a large volume of air through the intake. Fuel injection engines monitor this increase in air and compensate for such additional air by providing additional fuel to keep the mixture within a suitable range. Carburetors rely on jets and an accelerator pump to compensate for large increases in air intake. Traditional accelerator pumps simply spray a small amount of fuel into the engine to richen the mixture in an effort to try and achieve an acceptable air to fuel ratio. However, if the amount of fuel provided by the accelerator pump is insufficient, relative to the volume of the air, the engine can stall, hesitate or “bog”. Thus, it is common for accelerator pumps to be adjusted to provide excess fuel to prevent the engine from bogging.

Carburetors are primarily tuned relative to the altitude and temperature in which they are utilized, and may be tuned relative to the fuel grade and brand of the carburetor. Traditional carburetor tuning is accomplished in at least two steps. First, the internal jetting of the carburetor is tuned to match use conditions. Next, and secondarily, the accelerator pump may be tuned to match the air flow. Accelerator pump performance is generally tuned in an effort to optimize at least three factors: (a) timing of fuel supply, (b) duration of fuel supply, and (c) volume of fuel supply, so as to facilitate optimal power output of the engine. One known carburetor (Keihin FCR) allows for the adjustment of the first two factors: timing and duration of fuel supply. However, the last factor, volume of fuel supply, cannot be readily adjusted by this carburetor. Indeed, even major adjustments in duration of fuel supply generally only marginally assist in adjusting the volume of fuel supply over a given time period. To adequately adjust the volume of fuel supplied by the accelerator pump, conventional practice is to utilize different parts (e.g., different pump diaphragms and/or internal jets) based on use conditions. Such parts swapping/replacement is time consuming and expensive.

### SUMMARY OF THE DISCLOSURE

Broadly, the instant disclosure relates to adjustable accelerator pump covers and systems and methods relating to the same. In one aspect, an accelerator pump cover is provided. In one approach, the accelerator pump cover includes a body having a cavity for receiving fuel, a first passageway for allowing passage of fuel into the cavity, a second passageway for allowing passage of fuel out of the cavity, and an adjustable member at least partially disposed within at least a portion of one of the first passageway and the second passageway. In one embodiment, the adjustable member is capable of selective advancement and retraction within the body. Thus, selective amounts of fuel may be returned to the fuel reservoir and/or selective amounts of fuel may be supplied to another device (e.g., a carburetor and/or leak jet).

In one embodiment, the adjustable member includes a distal end portion in communication with the second passageway and a proximal end portion in communication with an exterior of the body. In one embodiment, the proximal end portion includes a mating feature for mating with an adjustment tool. In one embodiment, the distal end portion of the adjustable member comprises a tapered head. In one embodiment, the adjustable member is an elongated body comprising the distal end portion and the proximal end portion.

In one embodiment, the accelerator pump cover includes a tunnel in communication with the second passageway. In this embodiment, at least a portion of the adjustable member is disposed within the tunnel, and a distal end portion of the adjustable member is positioned in at least one of the second passageway and the tunnel. In one embodiment, the tunnel includes first complementary features and the adjustable member includes second complementary features for interconnection with the first complementary features of the tunnel. In one embodiment, the first complementary features are one of male and female threads, and the second complementary features are the other of the male and female threads.

The accelerator pump cover may include one or more features for facilitating sealing about the adjustable member so as to restrict/prevent fuel from leaking out of the body via the adjustable member. In one embodiment, a sealing member is located near a distal end of the tunnel and sealingly engages a perimeter of the adjustable member.

The accelerator pump cover may include one or more feature for restricting/preventing inadvertent movement of the adjustable member. In one embodiment, a spring member disposed within the tunnel and is interconnected with the adjustable member so as to provide a tensioning force on the adjustable member.

The accelerator pump cover generally includes at least the above-described first and second passageways. In one embodiment, the accelerator pump cover includes a third passageway, and the adjustable member is at least partially disposed within at least a portion of one of the first, second and third passageways. In one embodiment, the third passageway facilitates passage of fuel out of the fuel cavity. In one embodiment, the third passageway facilitates passage of fuel into the cavity. In one embodiment, the first passageway facilitates passage of fuel from a fuel reservoir to the cavity, the second passageway facilitates passage of fuel from the cavity to the fuel reservoir, and the third passageway facilitates passage of fuel from the cavity to an outside device (e.g., a carburetor).

In another approach, an accelerator pump cover may include a body having a cavity for receiving fuel from a fuel reservoir, a first passageway for facilitating passage of fuel into the cavity from the fuel reservoir, a second passageway for facilitating passage of fuel from the cavity to the fuel reservoir, a third passageway for facilitating passage of fuel to an inlet of a carburetor, an extension coupled to the body, and an elongated member at least partially disposed within the extension. In this approach, the elongated member may include a proximal end in communication with an exterior of the body and a distal end in communication with the second passageway. In one embodiment, the elongated member is capable of selective advancement and retraction within the extension to selectively position the distal end relative to the second passageway. This and other related accelerator pump covers of the instant disclosure may be used in any suitable single cylinder engine.

In another aspect, methods are provided. In one approach, a method includes opening a throttle of a single-cylinder engine, supplying a first amount of fuel to a carburetor of a single-cylinder engine via an accelerator pump cover in response to the opening step when an adjustable member of the accelerator pump cover is in a first position, and supplying a second amount of fuel to a carburetor of a single-cylinder engine via an accelerator pump cover in response to the opening step when an adjustable member of the accelerator pump cover is in a second position. In one embodiment, the method includes selectively moving the adjustable member of the accelerator pump cover from the first position to the second position. In one embodiment, this selectively moving step occurs while the single-cylinder engine is operating. In one embodiment, the method includes selectively moving the adjustable member within at least a portion of a return passageway, where the return passageway connects a fuel cavity of the accelerator pump cover to a fuel reservoir of the carburetor. In one embodiment, the method includes returning at least a portion of the fuel to the fuel reservoir via the return passageway.

### BRIEF DESCRIPTION OF THE DRAWINGS

FIGS. 1a and 1b are perspective views of one embodiment of a diaphragm cover with various portions cut-away to show internal features.

FIG. 2 is a perspective view of the diaphragm cover of FIGS. 1a and 1b without the diaphragm attached thereto.

FIG. 3 is an exploded view of the diaphragm cover of FIGS. 1a and 1b.

FIG. 4 is an exploded perspective view of one embodiment of a carburetor having an accelerator pump cover of the instant disclosure.

FIG. 5 is a schematic view illustrating one embodiment of a fuel flow methodology of the instant disclosure.

FIG. 6a is a schematic view illustrating another embodiment of a fuel flow methodology of the instant disclosure.

FIG. 6b is a schematic view illustrating another embodiment of a fuel flow methodology of the instant disclosure.

### DETAILED DESCRIPTION

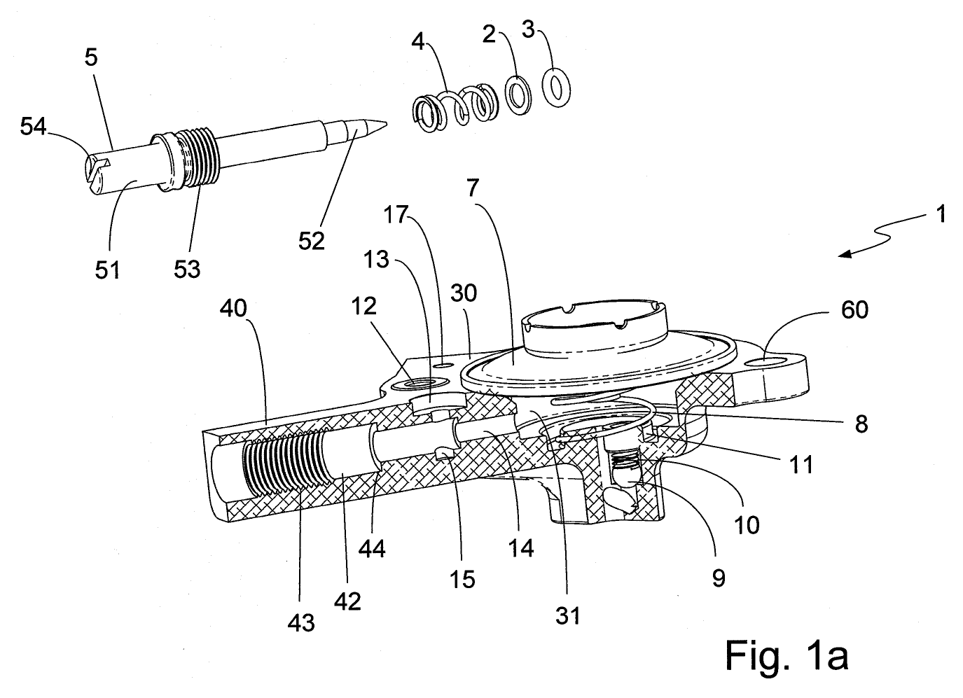

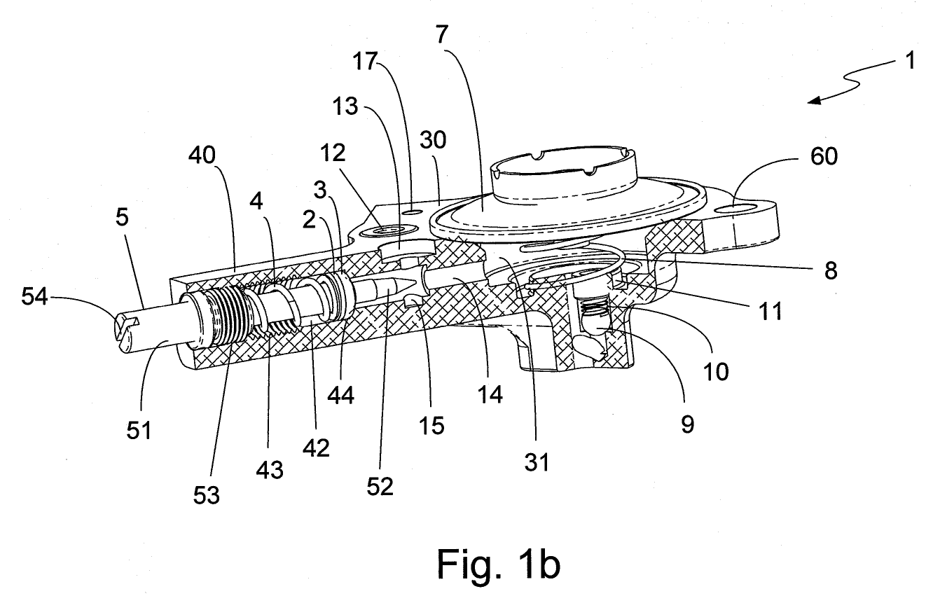

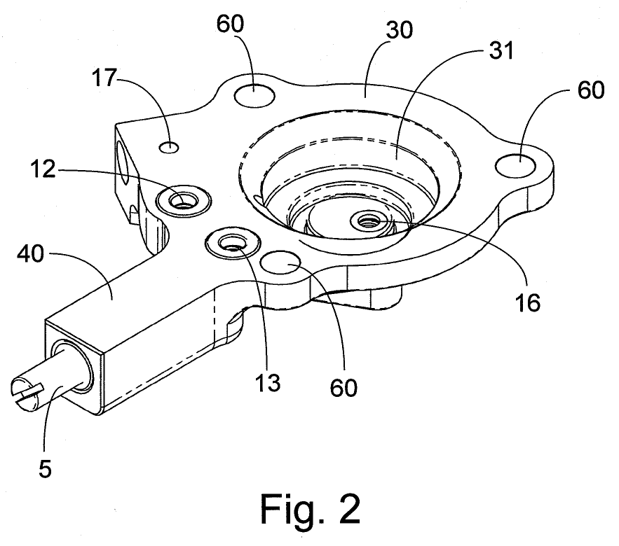

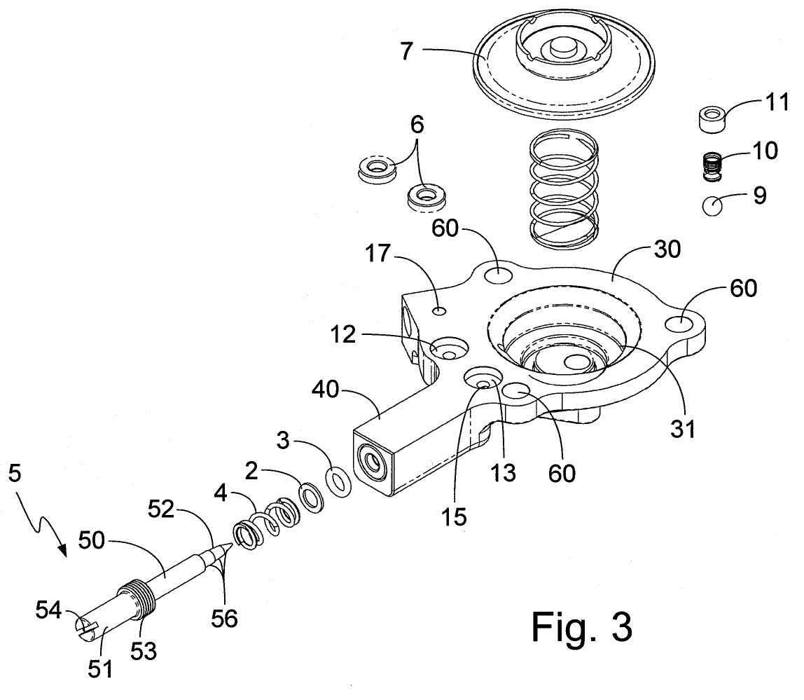

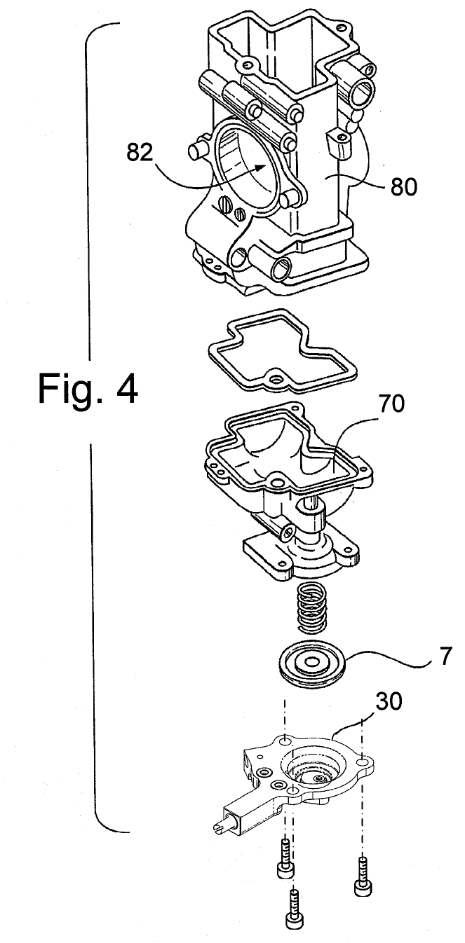

Reference will now be made to the accompanying drawings, which at least assist in illustrating various pertinent features of the instant disclosure. FIGS. 1a, 1b and 2-4 illustrate one embodiment of an accelerator pump cover and corresponding connecting features. In the illustrated embodiments, an accelerator pump system 1 includes an accelerator pump cover main body 30 and an extension 40. The main body 30 and extension 40 may be integral (e.g., a monolithic body) or separate components. The main body portion 30 includes a cavity 31 and a check valve 16 located in a lower portion of the main body 30. A diaphragm 7 is interconnected with the main body 30 via a spring 8 so as to cover the top of cavity 31. The check valve 16 may include a check valve cap 11, a check valve spring 10 and a ball 9. The main body 30 may also include holes 60 for facilitating interconnection of the main body 30 and diaphragm 7 to a fuel bowl 70 of a carburetor 80. The main body 30 further includes a fuel inlet passageway 17 for receiving fuel from the fuel bowl 70 (also known as a float bowl or fuel reservoir), and a main fuel supply passageway 12 (also sometimes referred to herein as a main fuel outlet) for supplying fuel to the accelerator pump nozzle(s) of a carburetor 80 via a venturi (or similar inlet) 82.

In prior accelerator pump designs, the main fuel supply passageway was further interconnected with a leak jet (not illustrated) that allowed excess fuel back into the fuel bowl 70. In one embodiment of the present disclosure, the main fuel supply passageway 12 does not fluidly communicate with the leak jet. Instead, and as described in further detail below, excess fuel may be returned to the fuel bowl 70 via a return passageway 14 (also referred to herein as a leak passageway) and corresponding return outlet 13 (also referred to herein as a leak outlet) that is in communication with the fuel bowl 70. Thus, the leak jet of a conventional accelerator pump may be closed (e.g., via a plug), or in some instances may be absent from the carburetor.

To facilitate selective supply of fuel to the accelerator pump nozzle(s), an adjustable member 5 may be employed in conjunction with the extension 40, the leak passageway 14 and the leak outlet 13. In the illustrated embodiment, the extension 40 includes a tunnel 42 for receiving the adjustable member 5 (e.g., a screw). The proximal portion of the tunnel 42 generally includes complementary features 43 (e.g., female threads) for receiving corresponding complementary features 53 (e.g., male threads) of the adjustable member 5. The distal portion of the tunnel 42, the leak passageway 14 and the leak outlet 13 are fluidly interconnected via bore 15. Thus, fluid communication between the cavity 31 and the leak outlet 13 is facilitated.

The adjustable member 5 may include an elongated body 50 having a proximal end 51, and a distal end 52. The proximal end 51 may include a mating feature 54 (e.g., slot(s), a geometric head) for receiving a tool or other adjusting apparatus (e.g., a screwdriver, a wrench). The distal end 52 of the adjustable member may include a head and/or one or more tapered portions 56 relative to the body 50. The adjustable member 5 may further include complementary features 53 adapted for interconnection with the complementary features 43 of the tunnel 42.

The adjustable member 5 may be selectively positioned to adjust the amount of fuel that flows from the cavity 31 to the leak outlet 13 via leak passageway 14 and/or bore 15. In particular, the adjustable member 5 may be selectively retracted away from or advanced toward the leak passageway 14 to adjust the amount of fuel flowing through passageway 14 and/or bore 15. In this regard, the distal end 52 and the tapered portion 56 thereof may be used to restrict flow through passageway 14 and/or bore 15. As the adjustable member 5 is advanced toward and relative to the leak passageway 14, a greater amount of the distal end 52 will be positioned within the bore 15 and/or leak passageway 14, thereby further restricting the flow of fuel to the leak outlet 13. In turn, a greater amount of fuel will be supplied to the accelerator pump nozzle(s) via the main fuel supply passageway 12, and less fuel will be returned to the fuel bowl 70. Likewise, as the adjustable member 5 is retracted away from and relative to the leak passageway 14, a lesser amount of the distal end 52 will be positioned within the bore 15 and/or leak passageway 14, thereby facilitating greater amounts of fuel to flow to the leak outlet 13. In turn, a lesser amount of fuel will be supplied to the accelerator pump nozzle(s) via the main fuel supply passageway 12, and more fuel will be returned to the fuel bowl 70. The tapered portions 56 may be sized/tailored relative to the leak passageway 14 and/or bore 15 to facilitate adjustment of excess fuel supply via the leak outlet 13.

The adjustable member 5 may be selectively moved/positioned relative to the leak passageway 14 via the complementary features 43, 53. In one embodiment, the adjustable member 5 is rotated (e.g., clockwise or counterclockwise) to facilitate advancement or retraction of the adjustable member 5 relative to the leak passageway 14.

Other features may be utilized to facilitate operation of the carburetor in conjunction with the accelerator pump cover 30 (sometimes called a diaphragm cover). For example, an o-ring backwasher 2 and o-ring seal 3 may be employed with the adjustable member 5 and tunnel 42 to fluidly isolate the distal end of the tunnel 42 from the leak passageway 14, bore 15 and/or leak outlet 13. In the illustrated embodiment of FIG. 1b, the o-ring backwasher 2 and o-ring seal 3 are positioned within the tunnel 42 and abut a face 44 of the tunnel 42, with the o-ring seal 3 facing the leak passageway 14. Hence, sealing of the distal end of the tunnel 42 is effected. Cover seals 6 may also be employed with the main fuel outlet 12 and leak outlet 13.

A spring member 4 may be employed with the adjustable member 5 and tunnel 42 to provide a tension force for maintaining the adjustable member 5 in an adjusted position. More particularly, a first end of the spring member 4 may abut the complementary features 53 of the adjustable member 5, while a second end of the spring member 4 may abut the face 44 of the tunnel 42 via the o-ring backwasher 2 and o-ring seal 3, thereby compressing the spring member 4 and providing a tension force on the adjustable member 5. Hence, unwanted movement of the adjustable member 5 may be restricted/prevented.

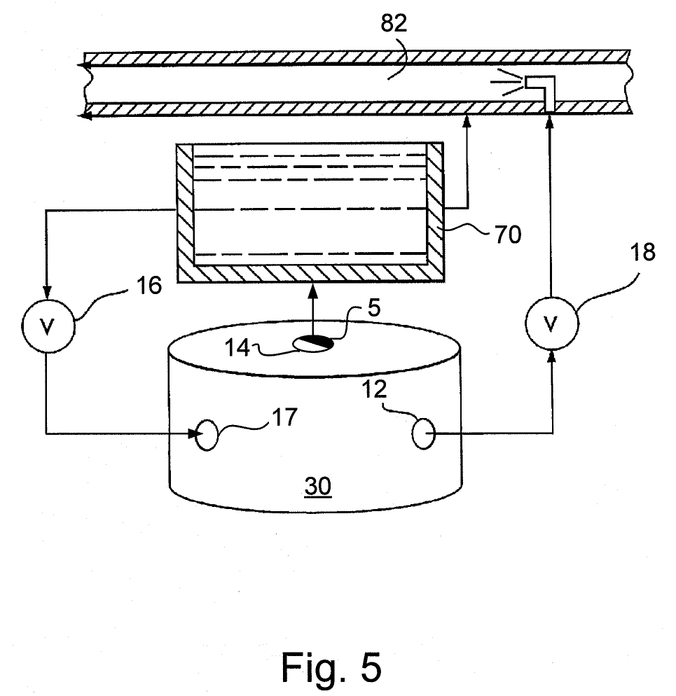

In one mode of operation, and with reference to FIGS. 1b and 5, a throttle cable (not illustrated) may be interconnected with a cam style ramp (not illustrated), which is interconnected with a pushrod and a spring-loaded arm (not illustrated). When the throttle is opened, the cam is rotated and the cam style ramp operates a pushrod via the spring-loaded arm. The spring-loaded arm pushes the diaphragm 7 down, which creates a pressure within cavity 31. When the throttle is released, the diaphragm 7 is allowed to move up (via spring 8), thereby creating a vacuum and drawing fuel into the cavity 31 via the inlet passage 17 by way of the check valve 16. Fuel is then supplied to the accelerator pump nozzle(s) via the main fuel supply passageway 12 by way of check valve 18. The volume of fuel supplied to the accelerator pump nozzle(s) via the main fuel supply passageway 12 may be readily increased or decreased by advancing or retracting, respectively, the adjustable member 5 relative to the leak passageway 14 so as to suitably position distal end 52 and tapered portions 56 of the adjustable member relative to the leak passageway 14 and/or bore 15. For example, if a larger volume of fuel supply is required, the adjustable member 5 may be advanced, thereby restricting fuel flow through the leak passageway 14 and the leak outlet 13, and increasing the amount of fuel flow through main fuel passageway 12. If a smaller volume of fuel supply is required, the adjustable member 5 may be retracted, thereby allowing larger amounts of fuel through the leak passageway 14 and the leak outlet 13 and back to the fuel bowl 70, and decreasing the amount of fuel flow through the main supply passageway 12. Hence, the volume of fuel supplied to the accelerator pump may be readily adjusted, without disassembly of the carburetor, and without the replacement/switching of parts relative to the environment in which the single-cylinder engine is utilized.

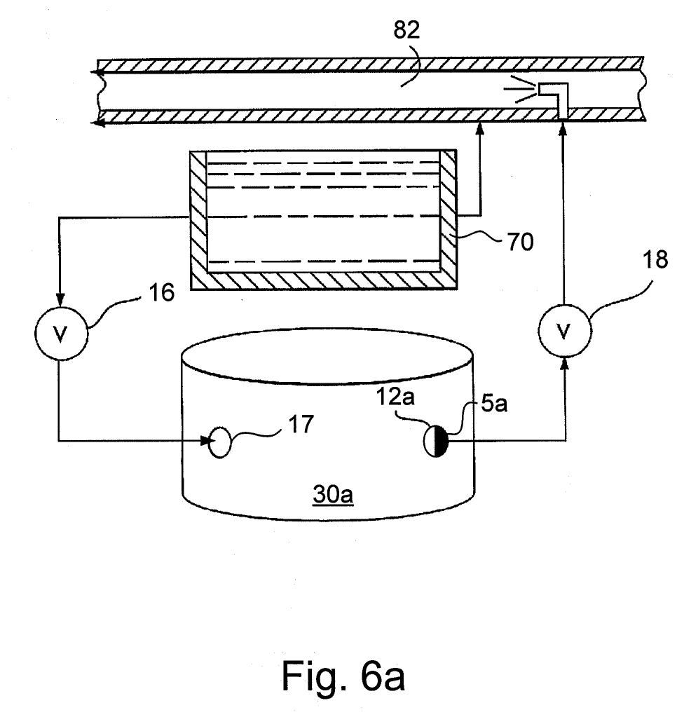

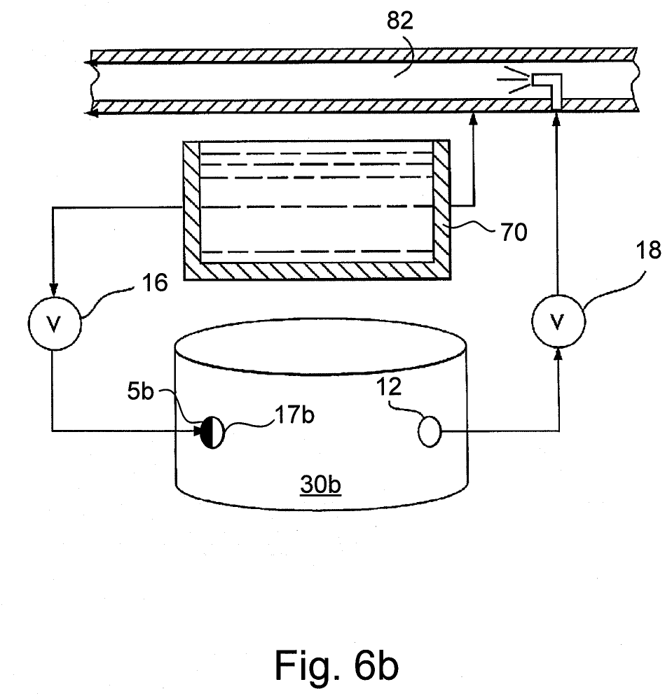

Other configurations may be utilized. For example, and with reference to FIG. 6a, instead of the adjustable member being located relative to return passageway 14, the adjustable member 5a may be located relative to the main fuel outlet 12a. In this embodiment, fuel flow to the accelerator pump nozzle(s) may be restricted directly via the selective advancement and retraction of the adjustable member 5a relative to the main fuel outlet 12a of the accelerator pump cover 30a. In the illustrated embodiment, the return passageway 14 is absent, but in other configurations the return passageway 14 may be included, and with or without a second adjustable member.

In another approach, and with reference to FIG. 6b, instead of the adjustable member being located relative to return passageway 14, the adjustable member 5b may be located relative to the fuel inlet passageway 17b. In this embodiment, fuel flow to the cavity of the accelerator pump cover 30b may be restricted directly via the selective advancement and retraction of the adjustable member 5b relative to the fuel inlet passageway 17b. In the illustrated embodiment, the return passageway 14 is absent, but in other configurations the return passageway 14 may be included, and with or without a second adjustable member.

Methods of adjusting accelerator pumps are also provided. For example, one method may include the step of opening a throttle of a single-cylinder engine, supplying a first amount of fuel to a carburetor via an accelerator pump cover, and supplying a second amount of fuel to the carburetor via the accelerator pump cover. The first amount of fuel may be supplied to the carburetor when an adjustable member is in a first position, and the second amount of fuel may be supplied to the carburetor when the adjustable member is in a second position. Concomitant to the supplying the first amount of fuel step, a first amount of fuel may be returned from the accelerator pump cover to a fuel reservoir of a carburetor. Likewise, concomitant to the supplying the second amount of fuel step, a second amount of fuel may be returned to the fuel reservoir. As described above, the first amount of the fuel may be supplied to the carburetor via a main fuel supply passageway, and another portion of the fuel may be returned to the fuel reservoir via the return passageway located within the accelerator pump cover. The amount of fuel supplied to the carburetor during the supplying the first amount of fuel step may be any suitable amount of fuel adapted to be supplied by the accelerator pump via the accelerator pump cover and the main supply passageway and will be based on the position of the adjustable member. Likewise, the portion of fuel returned to the fuel reservoir will be based upon the position of the adjustable member within the accelerator pump cover. In one embodiment, the adjustable member in the first position is fully advanced and no fuel is returned to the fuel reservoir. In another embodiment, the adjustable member is fully retracted, thereby allowing significant amounts of fuel to return to the fuel reservoir via the return passageway. Similar criteria apply to when the adjustable member is in the second position.

As described above, varying amounts of fuel are supplied to the carburetor based upon the position of a adjustable member. In one embodiment, the method includes selectively moving the adjustable member from/to the first position to/from the second position. As described above, the adjustable member may be positioned/moved relative to a return passageway, a main fuel supply passageway, or a fuel inlet passageway. To selectively move the adjustable member, the member may be, for example, rotated in a clockwise or counterclockwise direction. Other configurations may be utilized to selectively move the adjustable member. In one embodiment, the adjustable member may be selectively adjusted when the single-cylinder engine is running. The accelerator pump cover and corresponding parts, including the adjustable member, may be any of the above-described accelerator pump covers and/or adjustable members.

As described above, the accelerator pump cover may be utilized in conjunction with any various types of single-cylinder engines, such as single-cylinder engines used in automobiles, motorcycles, ATVs, motorboats and/or lawnmowers, to name a few.

The novel features of the invention set forth in part in the above description will become apparent to those skilled in the art upon examination of the foregoing description and figures, or may be learned by practicing the invention. Moreover, while various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. An accelerator pump cover comprising:
a body having a cavity for receiving fuel;
a first passageway for allowing passage of fuel into the cavity;
a second passageway for allowing passage of fuel out of the cavity; and
an adjustable member at least partially disposed within at least a portion of one of the first passageway and the second passageway.

2. The pump cover of claim 1, wherein the adjustable member is capable of selective advancement and retraction within the body.

3. The pump cover of claim 2, wherein the adjustable member comprises:
a distal end portion in communication with the second passageway; and
a proximal end portion in communication with an exterior of the body.

4. The pump cover of claim 3, wherein the proximal end portion comprises a mating feature for mating with an adjustment tool.

5. The pump cover of claim 3, wherein the distal end portion of the adjustable member comprises a tapered head.

6. The pump cover of claim 3, wherein the adjustable member is an elongated body comprising the distal end portion and the proximal end portion.

7. The pump cover of claim 1, further comprising:
a tunnel in communication with the second passageway, wherein at least a portion of the adjustable member is disposed within the tunnel, and wherein a distal end portion of the adjustable member is positioned in at least one of the second passageway and the tunnel.

8. The pump cover of claim 7, wherein the tunnel includes first complementary features, and wherein the adjustable member includes second complementary features for interconnection with the first complementary features of the tunnel.

9. The pump cover of claim 8, wherein the first complementary features are one of male and female threads, and the second complementary features are the other of the male and female threads.

10. The pump cover of claim 7, further comprising:
a sealing member located near a distal end of the tunnel.

11. The pump cover of claim 7, further comprising:
a spring member disposed within the tunnel.

12. The pump cover of claim 1, further comprising:
a third passageway for allowing passage of fuel out of the cavity.

13. The pump cover of claim 13, wherein the first passageway facilitates passage of fuel from a fuel reservoir to the cavity, wherein the second passageway facilitates passage of fuel from the cavity to the fuel reservoir, and wherein the third passageway facilitates passage of fuel from the cavity to a carburetor.

14. An accelerator pump cover comprising:
a body having a cavity for receiving fuel from a fuel reservoir;
a first passageway for facilitating passage of fuel into the cavity from the fuel reservoir;
a second passageway for facilitating passage of fuel from the cavity to the fuel reservoir;
a third passageway for facilitating passage of fuel to an inlet of a carburetor;
an extension coupled to the body; and
an elongated member at least partially disposed within the extension, wherein the elongated member comprises:
a proximal end in communication with an exterior of the body; and
a distal end in communication with the second passageway;
wherein the elongated member is capable of selective advancement and retraction within the extension to selectively position the distal end relative to the second passageway.

15. A single-cylinder engine comprising the pump cover of claim 14.

16. A method comprising:
opening a throttle of a single-cylinder engine;
supplying a first amount of fuel to a carburetor of a single-cylinder engine via an accelerator pump cover in response to the opening step when an adjustable member of the accelerator pump cover is in a first position; and
supplying a second amount of fuel to a carburetor of a single-cylinder engine via an accelerator pump cover in response to the opening step when an adjustable member of the accelerator pump cover is in a second position.

17. The method of claim 16, comprising:
selectively moving the adjustable member of the accelerator pump cover from the first position to the second position.

18. The method of claim 17, wherein the selectively moving step occurs while the single-cylinder engine is operating.

19. The method of claim 17, wherein the selectively moving step comprises:
selectively moving the adjustable member within at least a portion of a return passageway, wherein the return passageway connects a fuel cavity of the accelerator pump cover to a fuel reservoir of the carburetor.

20. The method of claim 19, further comprising returning at least a portion of the fuel to the fuel reservoir via the return passageway.
